(19) United States
(12) Patent Application Publication
(10) Pub. No.: US 2025/0293563 A1
(43) Pub. Date: Sep. 18, 2025

(54) ELECTRIC MACHINE WITH COOLING FEATURES

(71) Applicant: General Electric Deutschland Holding GmbH, Frankfurt (DE)

(72) Inventors: Israel Luna Acevedo, Munich (DE); Thanasekaran Gopal, Ingolstadt (DE); Rammohan Rao Kalluri, Garching (DE); Mohamed Osama, Garching (DE); Tamilselvan Srinivasan, Munich (DE)

(21) Appl. No.: 18/602,348

(22) Filed: Mar. 12, 2024

(51) Int. Cl. H02K 3/24; H02K 1/16; H02K 1/20; H02K 5/10; H02K 5/20

(52) U.S. Cl. CPC H02K 3/24; H02K 1/16; H02K 1/20; H02K 5/10; H02K 5/20

(57) ABSTRACT

An electric machine defining a radial direction, a circumferential direction, and an axial direction includes a stator core and a plurality of stops. The stator core includes a first end and a second end opposing the first end in the axial direction. The stator core defines a plurality of slots extending in the axial direction from the first end to the second end and a plurality of channels extending in the axial direction from the first end to the second end. Each one of the plurality of channels is disposed between two adjacent ones of the plurality of slots in the circumferential direction. Each one of the plurality of stops is disposed in one of the plurality of slots and extends in the circumferential direction across a width of the respective one of the plurality of slots and in the axial direction from the first end to the second end.

### FIELD

The present disclosure relates to an electric machine for a gas turbine engine.

### BACKGROUND

Typical aircraft propulsion systems include one or more gas turbine engines. For certain propulsion systems, the gas turbine engines generally include a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gasses through the turbine section drives the turbine section and is then routed through the exhaust section, e.g., to atmosphere.

Incorporating an electrical machine (e.g., an electrical generator) into a propulsion engine to generate electrical power from mechanical energy generated by the propulsion engine may enhance the capabilities of aircraft. For example, the electrical power generated by the electrical machine may be used to operate an accessory propulsor (e.g., an electric fan, motor, or the like) to supplement thrust provided via the turbine engine.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of an exemplary gas turbine engine including an electric machine.

FIG. 2 is a perspective schematic view of a stator of the electric machine of the gas turbine engine of FIG. 1 including a cooling assembly.

FIG. 3 is an exploded schematic view of a stator core and seal member of the stator of FIG. 2.

FIG. 4 is a magnified schematic view of axial slots of the stator core of FIG. 3.

FIG. 5 is an exploded schematic view of the stator with outer casings of the cooling assembly.

FIG. 6 is a magnified schematic view of the stator core with channels defined therethrough.

FIG. 7A is a cross-sectional view of the stator core of FIG. 6 along the plane defined by the lines 7-7.

FIG. 7B is a cross-sectional view of another stator core . . .

FIG. 8 is a magnified schematic view of the stator core with extensions disposed on an exterior surface.

FIG. 9 is a cross-sectional view of another exemplary stator core.

FIG. 10 is a perspective view of another exemplary electric machine.

FIG. 11 is a cross-sectional view of the exemplary electric machine of FIG. 10 along the line 11-11.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The present disclosure is generally related to cooling electric machines in gas turbine engines. During operation, electric machines (such as electric motors and electric generators) generate heat and may be exposed to heat. The heat may interfere with operation of the electric machine, such as increasing an electrical resistance of windings that leads to a decreased magnetic field generated by the windings. Thermal management to dissipate heat leads to improved efficiency and lifespan of the electric machines.

Liquid coolants can provide heat transfer by convection, and providing a liquid coolant that contacts the windings in the stator dissipates heat from the windings directly. Flooding the stator with the liquid coolant and flowing the liquid coolant across the windings increases heat transfer from the windings, improving efficiency of the electric machine. By applying seals around the stator core to direct the coolant through slots of the stator core, the total amount of coolant may be reduced while maintaining heat transfer sufficient to cool the windings. Further, such a configuration may allow for liquid cooling without requiring a dedicated seal plate positioned in a rotor gap between a rotor and the stator of the electric machine, which increases a width of the rotor gap and can negatively affect torque and power density of the electric machine.

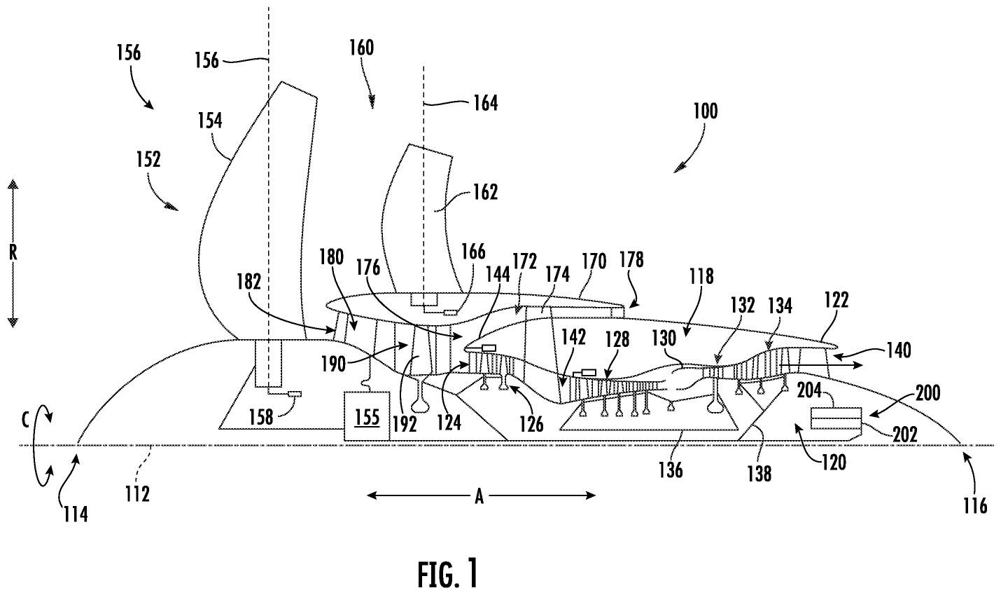

Referring now to the drawings, wherein identical numerals indicate the same elements throughout the figures, FIG. 1 is a schematic cross-sectional view of a gas turbine engine according to one example embodiment of the present disclosure is shown. Particularly, FIG. 1 provides an aviation three-stream turbofan engine herein referred to as “three-stream engine 100”. The three-stream engine 100 of FIG. 1 can be mounted to an aerial vehicle, such as a fixed-wing aircraft, and can produce thrust for propulsion of the aerial vehicle. The three-stream engine 100 is a “three-stream engine” in that its architecture provides three distinct streams of thrust-producing airflow during operation.

For reference, the three-stream engine 100 defines an axial direction A, a radial direction R, and a circumferential direction C. Moreover, the three-stream engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees) (360° around the longitudinal axis 112. The three-stream engine 100 extends between a forward end 114 and an aft end 116, e.g., along the axial direction A.

The three-stream engine 100 includes a core engine 118 and a fan section 150 positioned upstream thereof. Generally, the core engine 118 includes, in serial flow order, a compressor section, a combustion section, a turbine section, and an exhaust section. Particularly, as shown in FIG. 1, the core engine 118 includes an engine core 120 and a core cowl 122 that annularly surrounds the engine core 120. The engine core 120 and core cowl 122 define an annular core inlet 124. The core cowl 122 further encloses and supports a booster or low pressure compressor 126 for pressurizing the air that enters the core engine 118 through core inlet 124. A high pressure, multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air.

The high energy combustion products flow from the combustor 130 downstream to a high pressure turbine 132. The high pressure turbine 132 drives the high pressure compressor 128 through a first shaft or high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126, components of the fan section 150, and an electric machine 200 through a second shaft or low pressure shaft 138. Specifically, the high energy combustion products drive turbine blades 135 of the low pressure turbine 134. In this regard, the low pressure turbine 134 is drivingly coupled with the low pressure compressor 126, components of the fan section 150, and the electric machine 200. The LP shaft 138 is coaxial with the HP shaft 136 in this example embodiment. After driving each of the turbines 132, 134, the combustion products exit the core engine 118 through a core exhaust nozzle 140 to produce propulsive thrust. Accordingly, the core engine 118 defines a core flowpath or core duct 142 that extends between the core inlet 124 and the core exhaust nozzle 140. The core duct 142 is an annular duct positioned generally inward of the core cowl 122 along the radial direction R.

The fan section 150 includes a primary fan 152. For the depicted embodiment of FIG. 1, the primary fan 152 is an open rotor or unducted primary fan 152. However, in other embodiments, the primary fan 152 may be ducted, e.g., by a fan casing or nacelle circumferentially surrounding the primary fan 152. As depicted, the primary fan 152 includes an array of fan blades 154 (only one shown in FIG. 1). The fan blades 154 are rotatable, e.g., about the longitudinal axis 112. As noted above, the primary fan 152 is drivingly coupled with the low pressure turbine 134 via the LP shaft 138. The primary fan 152 can be directly coupled with the LP shaft 138, e.g., in a direct-drive configuration. Optionally, as shown in FIG. 1, the primary fan 152 can be coupled with the LP shaft 138 via a speed reduction gearbox 155, e.g., in an indirect-drive or geared-drive configuration.

Moreover, the fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the primary fan 152 is rotatable about their respective central blades axes 156, e.g., in unison with one another. One or more actuators 158 can be controlled to pitch the fan blades 154 about their respective central blades axes 156. However, in other embodiments, each fan blade 154 may be fixed or unable to be pitched about its central blade axis 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or may be shrouded, e.g., by an annular shroud spaced outward from the tips of the fan guide vanes 162 along the radial direction R. Each fan guide vane 162 defines a central blade axis 164. For this embodiment, each fan guide vane 162 of the fan guide vane array 160 is rotatable about their respective central blades axes 164, e.g., in unison with one another. One or more actuators 166 can be controlled to pitch the fan guide vane 162 about their respective central blades axes 164. However, in other embodiments, each fan guide vane 162 may be fixed or unable to be pitched about its central blade axis 164. The fan guide vanes 162 are mounted to a fan cowl 170.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flowpath or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced struts 174 (only one shown in FIG. 1). The struts 174 may each be aerodynamically contoured to direct air flowing thereby. Other struts in addition to struts 174 may be used to connect and support the fan cowl 170 and/or core cowl 122.

The three-stream engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the primary fan 152 and the fan guide vanes 162 of the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a nose of a splitter 144 of the core cowl 122. The inlet duct 180 is wider than the core duct 142 along the radial direction R. The inlet duct 180 is also wider than the fan duct 172 along the radial direction R.

As depicted, the fan section 150 also includes a mid-fan 190. The mid-fan 190 includes an array of mid-fan blades 192 (only one shown in FIG. 1). The mid-fan blades 192 are rotatable, e.g., about the longitudinal axis 112. Each mid-fan blade has a root, a tip, and a span defined therebetween. The mid-fan 190 is drivingly coupled with the low pressure turbine 134 via the LP shaft 138. The mid-fan blades 192 can be arranged in equal circumferential spacing around the longitudinal axis 112.

Accordingly, air flowing through the inlet duct 180 flows across the mid-fan blades 192 and is accelerated downstream thereof, particularly at the tips of the mid-fan blades 192. At least a portion of the air accelerated by the mid-fan blades 192 flows into the fan duct 172 and is ultimately exhausted through the fan exhaust nozzle 178 to produce propulsive thrust. Also, at least a portion of the air accelerated by the mid-fan blades 192 flows into the core duct 142 and is ultimately exhausted through the core exhaust nozzle 140 to produce propulsive thrust. Generally, the mid-fan 190 is a compression device positioned downstream of the engine inlet 182. The mid-fan 190 is operable to accelerate air into the fan duct 172 or secondary bypass passage.

Further, for the depicted embodiment of FIG. 1, the three-stream engine 100 includes an electric machine operably coupled with a rotating component thereof. In this regard, the three-stream engine 100 is an aeronautical hybrid-electric propulsion machine. Particularly, as shown in FIG. 1, the three-stream engine 100 includes electric machine 200 operatively coupled with the LP shaft 138. The electric machine 200 includes a rotor 202 and a stator 204. The electric machine 200 can be directly mechanically connected to the LP shaft 138, or alternatively, the electric machine 200 can be mechanically coupled with the LP shaft 138 indirectly, e.g., by way of a gearbox. Further, although the electric machine 200 is operatively coupled with the LP shaft 138 at an aft end of the LP shaft 138, the electric machine 200 can be coupled with the LP shaft 138 at any suitable location or can be coupled to other rotating components of the three-stream engine 100, such as the HP shaft 136.

In some embodiments, the electric machine 200 can be an electric motor operable to drive or motor the LP shaft 138, e.g., during an engine burst. In other embodiments, the electric machine 200 can be an electric generator operable to convert mechanical energy into electrical energy. In this way, electrical power generated by the electric machine 200 can be directed to various engine and/or aircraft systems. In some embodiments, the electric machine 200 can be a motor/generator with dual functionality.

It will be appreciated that in other exemplary embodiments of the present disclosure, the exemplary electric machine 200 may be positioned at any other location within the three-stream engine 100. For example, in other embodiments, the electric machine 200 may be embedded within the three-stream engine 100 inward of the compressor section, outward of the working gas flowpath in an under-cowl area, in a nose cone of the three-stream engine 100, etc.

It will be appreciated, however, that the exemplary three-stream engine 100 is provided by way of example only. In other exemplary embodiments, the three-stream engine 100 may have any other configuration. For example, in other exemplary embodiments, the engine core 120 may have any other number and arrangement of shafts, spools, compressors, turbines, etc. Further, in other exemplary embodiments, the three-stream engine 100 may alternatively be configured as a ducted turbofan engine (including an outer nacelle surrounding the primary fan 152 and a portion of the engine core 120); as a direct drive gas turbine engine (may not include a reduction gearbox, such as the speed reduction gearbox 155); as a fixed pitch gas turbine engine (may not include a variable pitch fan, such as the primary fan 152); as a two-stream gas turbine engine (may not include the fan duct 172); etc.

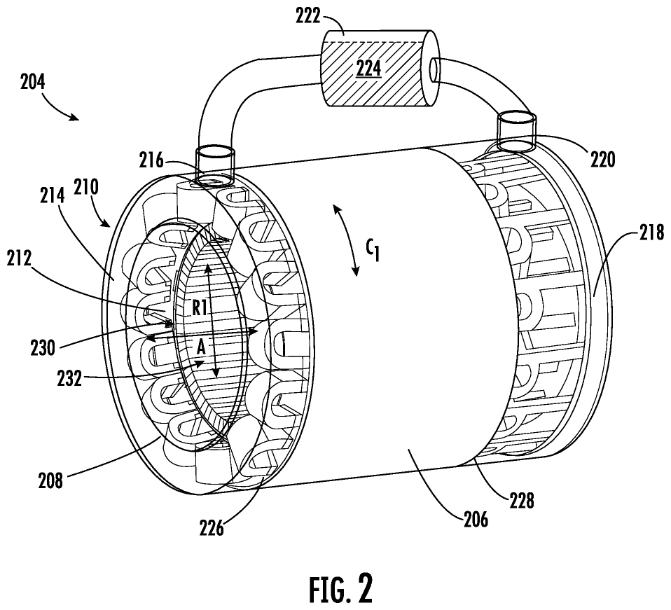

Now referring to FIG. 2, a perspective schematic view of the stator 204 of the electric machine 200 is shown. In particular, the stator 204 is shown to illustrate each of the components that will be explained further in detail below. It will be appreciated that, while the rotor 202 is not shown in FIG. 2, the stator 204 is configured to receive the rotor 202 to form the electric machine 200.

The stator 204 of the electric machine 200 includes a stator core 206 defining an axial direction A1, a radial direction R1, and a circumferential direction C1, a plurality of windings 208, and a cooling assembly 210. The cooling assembly 210 includes a seal member 212, a first outer casing 214 including a first fluid port 216, a second outer casing 218 including a second fluid port 220, and a fluid supply 222 including a coolant fluid 224. The stator core 206 includes a first end 226 and a second end 228 and defines a plurality of axial slots 230 extending in the axial direction A1 from the first end 226 to the second end 228. The cooling assembly 210 provides the coolant fluid 224 to the windings 208 disposed in the axial slots 230 the stator core 206, flooding the stator 204 with the coolant fluid 224 to cool the electric machine 200.

As stated above, the stator 204 includes the stator core 206. It will be appreciated that the directions R1, A1, C1 of the stator core 206 are locally defined with respect to the stator core 206. However, in the embodiment shown, the axial direction A1 is arranged parallel to the axial direction A of the three-stream engine 100. The stator core 206 houses other components of the stator 204, including the plurality of windings 208 and the cooling assembly 210. The stator 204 defines an axial cavity in which the rotor 202 (not shown) rotates. When the electric machine 200 operates as a generator, the rotating rotor 202 generates an electric field that induces current flow through the windings 208. When the electric machine 200 operates as a motor, the windings 208 and the stator 204 generate an electric field that induces rotational motion of the rotor 202.

The windings 208 are suitable conductors that allow current flow to generate the electric field. As an example, the windings 208 may include a plurality of wires, such as Litz wire conductors or stranded conductors. The specific gauge and length of the wires may be determined based on the specific electric field generation for the electric machine 200. Alternatively or additionally, the windings 208 may include solid elements, such as hairpin conductors or preformed solid coils. The solid elements may be define gaps between adjacent ones of the solid elements that allow the coolant fluid 224 to flow through.

The seal member 212 of the cooling assembly 210 extends through the plurality of axial slots 230 in the axial direction from the first end 226 of the stator core 206 to the second end 228 of the stator core 206. The plurality of windings 208 extend through the seal member 212 in the plurality of axial slots 230 such that the seal member 212 surrounds the plurality of windings 208 within each of the plurality of axial slots 230. The seal member 212 is formed of a material with fluidtight properties, such as a polymer.

The first outer casing 214 is disposed at the first end 226 over the seal member 212, and the second outer casing 218 is disposed at the second end 228 over the seal member 212. The first and second outer casings 214, 218 and the seal member 212 form a fluidtight chamber that encapsulates the plurality of windings 208 within the plurality of axial slots 230. The first and second outer casings 214, 218 thus inhibit leaking of the coolant fluid 224 from the electric machine 200. Additional seals (not shown) may be disposed around the first end 226 and the second end 228 and engaging the first outer casing 214 and the second outer casing 218, forming the fluidtight chamber.

The fluid supply 222 is in fluid communication with the first fluid port 216 of the first outer casing 214 and the second fluid port 220 of the second outer casing 218. The fluid supply 222 provides coolant fluid 224 to the first fluid port 216 of the first outer casing 214, and the coolant fluid 224 flows through the fluidtight chamber along the plurality of windings 208 from the first end 226 of the stator core 206 to the second end 228 of the stator core 206. The coolant fluid 224 then flows to the second fluid port 220 of the second outer casing 218 and back to the fluid supply 222. While one first fluid port 216 is shown in the exemplary embodiment of FIG. 2, it will be appreciated that the first outer casing 214 may include two or more ports that communicate the coolant fluid 224 from the fluid supply 222.

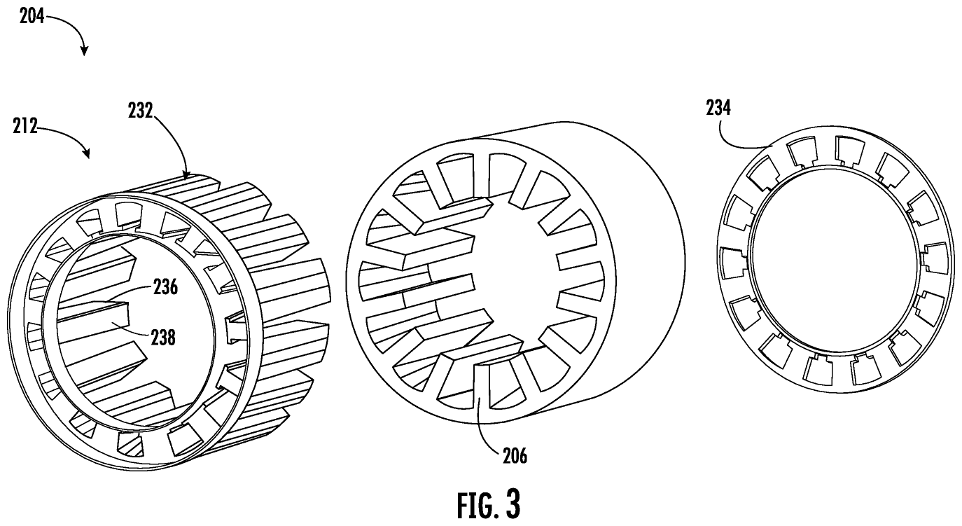

Now referring to FIG. 3, the stator core 206 and the seal member 212 are shown in an exploded perspective view. More specifically, the seal member 212 is shown separate from the first and second ends 226, 228 of the stator core 206 to illustrate the location of the seal member 212 relative to the stator core 206.

The seal member 212 includes a plurality of axial seals 232 and a terminal seal 234. The axial seals 232 extend around the first end 226 of the stator core 206 in the circumferential direction C1. Each of the axial seals 232 includes a slot member 236. Each slot member 236 extends through one of the axial slots 230 from the first end 226 of the stator core 206 to the second end 228 of the stator core 206. That is, each slot member 236 extends through each axial slot 230 to allow the coolant fluid 224 to flow through the axial seal 232 without directly contacting the stator core 206. The slot member 236 thus forms a fluidtight barrier protecting the stator core 206. The slot member 236 is generally an elongated piece of fluid-resistant material extending from the first end 226 to the second end 228. A stop 238 encloses each slot member 236.

The terminal seal 234 is disposed at the second end 228 of the stator core 206 and secures the slot member 236 of each axial seal 232 to the stator core 206. More specifically, the terminal seal 234 is shaped to form a fluidtight barrier with the slot member 236, allowing the coolant fluid 224 to flow out from the axial slot 230 without directly contacting the stator core 206. The terminal seal 234 forms a friction fit with the stator core 206, securing the terminal seal 234 against the second end 228.

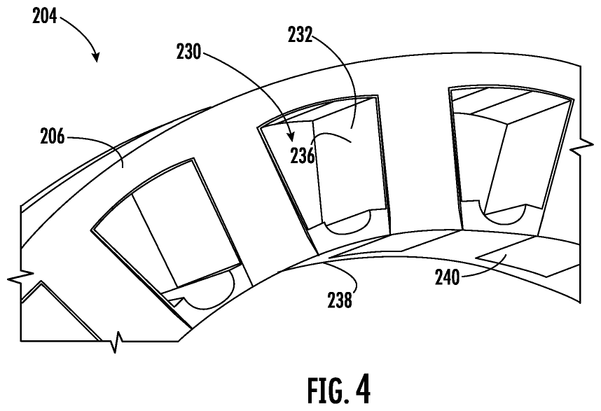

With reference to FIG. 4, a partial cross-sectional view of the stator core 206 with the seal member 212 is shown. More specifically, the second end 228 of the stator core 206 is shown to illustrate the stops 238 in the axial slots 230.

The seal member 212 includes a plurality of the stops 238. Each stop 238 encloses one of the slot members 236 in each of the plurality of axial slots 230. Each of the stops 238 is disposed in one of the axial slots 230, forming a friction fit that wedges the stop against the stator core 206, inhibiting the stop from loosening from the stator core 206 when the coolant fluid 224 floods the seal member 212. Each stop 238 extends in the circumferential direction C1 across a width W of its respective axial slot 230. Each stop 238 extends in the axial direction A1 from the first end 226 to the second end 228. The stator core 206 defines an inner surface 240 in the radial direction R1, and the plurality of stops 238 is substantially flush with the inner surface 240 of the stator core 206. That is, the plurality of stops 238 and the inner surface 240 conform to a circular surface that is substantially smooth. The slot members 236, the terminal seal 234, and the stops 238 form a sleeve or tube-like covering that covers the stator core 206 within each of the axial slots 230, inhibiting the coolant fluid 224 from contacting the stator core 206 or leaking out past the inner surface 240.

In such a manner, it will be appreciated that the inner surface 240 forms, with the plurality of stops 238, the inner-most surface of the stator 204, allowing for a desired gap width between the stator 204 and the rotor 202 (see FIG. 1) while also allowing for the fluid cooling discussed herein.

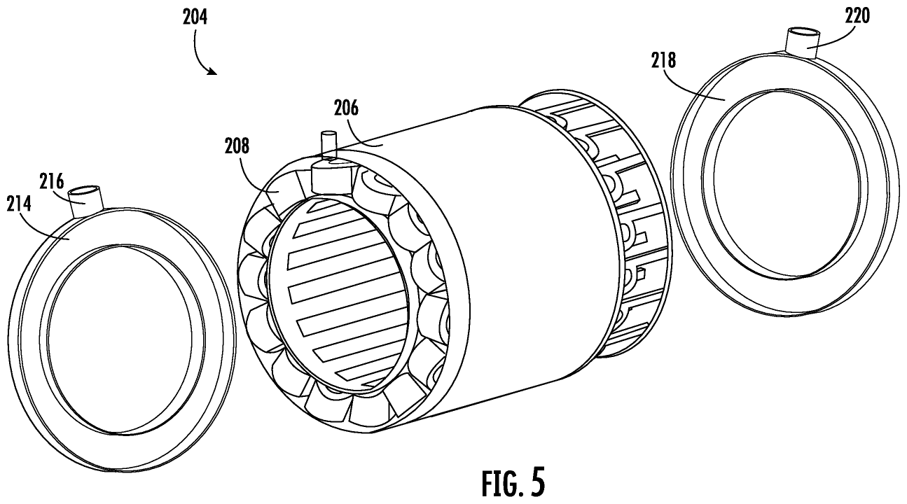

Now referring to FIG. 5, an exploded perspective view of the stator core 206 with the first and second outer casings 214, 218 is shown. More specifically, FIG. 5 shows the windings 208 disposed in the axial slots 230 of the stator core 206 and the first and second outer casings 214, 218 positioned at the first and second ends 226, 228 to cover the windings 208.

The first outer casing 214 is disposed at the first end 226 of the stator core 206 and the second outer casing 218 is disposed at the second end 228 of the stator core 206. When the first and second outer casings 214, 218 enclose the windings 208 within the seal member 212, the coolant fluid 224 floods the stator core 206 to transfer heat from the windings 208. More specifically, the coolant fluid 224 from the fluid supply 222 flows through the first fluid port 216 of the first outer casing 214, through each axial slot 230 around the windings 208, and out through the second fluid port 220 of the second outer casing 218. As the coolant fluid 224 flows through the stator core 206, the coolant fluid 224 transfers heat from the windings 208 by convective heat transfer, improving the efficiency of the electric machine 200.

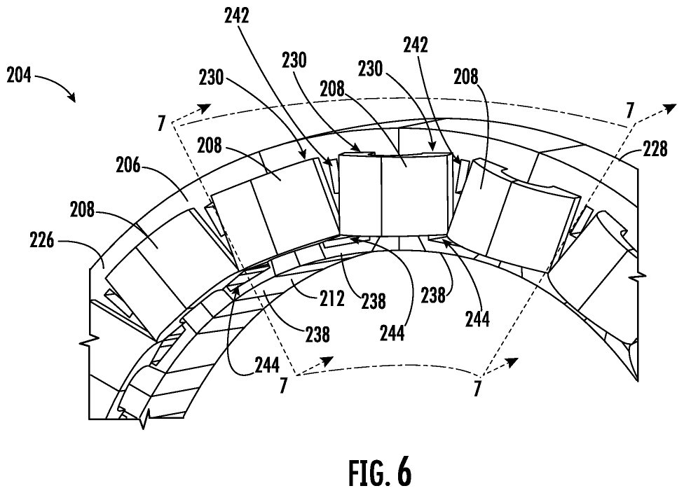

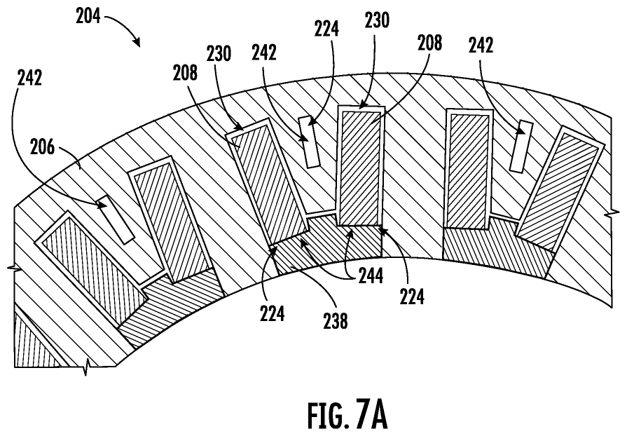

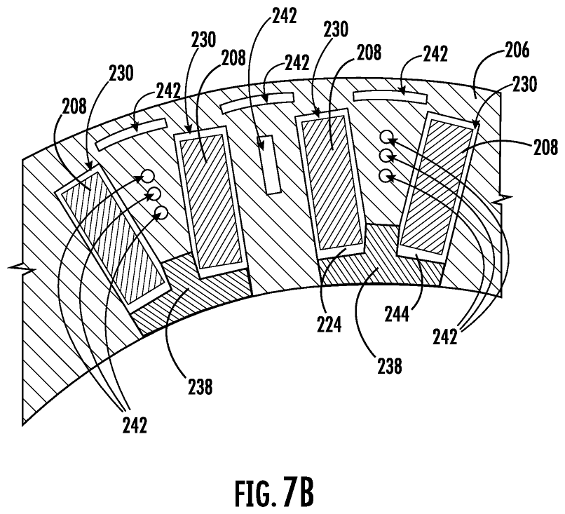

With reference to FIGS. 6-7B, a schematic view of the stator core 206 is shown without the cooling assembly 210. FIG. 6 shows a partial perspective view of the stator core 206 including the windings 208 and the stops. FIG. 7A shows a partial cross-sectional view along the plane 7-7, illustrating the windings 208 and the stops 238 enclosing the windings 208 within the axial slots 230. FIG. 7B shows another partial cross-sectional view, illustrating the windings 208 and the stops 238 enclosing the windings 208 in the axial slots 230.

The stator core 206 defines a plurality of channels 242 extending in the axial direction A1 from the first end 226 to the second end 228. Each of the plurality of channels 242 is disposed between two adjacent axial slots 230 in the circumferential direction C1. That is, as shown in FIG. 7A, one of the plurality of channels 242 is disposed between each pair of adjacent axial slots 230 such that each adjacent pair of windings 208 has a channel 242 defined therebetween. The channels 242 are fluidly separated from the axial slots 230 such that the coolant fluid 224 flows separately through the channels 242 and through the axial slots 230. The channels 242 thus provide cooling directly to portions of the stator core 206 that are heated by the adjacent windings 208. The channels 242 are in fluid communication with the first fluid port 216 of the first outer casing 214 (FIGS. 2, 5) to provide the coolant fluid 224 (FIG. 2) through the stator core 206.

In addition to the channels 242 between the axial slots 230, the stator core 206 may include additional channels 242 of differing shapes and locations, as shown in FIG. 7B. The channels 242 may be circular and disposed between adjacent ones of a pair axial slots 230. Additionally, the channels 242 may be rectangular and disposed between adjacent pairs of axial slots 230. Yet additionally, the channels 242 may be arcuate and disposed radially outward of the axial slots 230. It will be appreciated that the stator core 206 may define channels 242 of specific shape and location to provide specified cooling of the windings 208.

The stops 238 are disposed inward of the windings 208 in the radial direction R1 to define a plurality of stop channels 244. Each stop channel 244 extends from the first end 226 of the stator core 206 to the second end 228 of the stator core 206 in the axial direction A1. More specifically referring to FIGS. 7A-7B, the stop channels 244 allow the coolant fluid 224 to flow beneath the windings 208 in the axial slots 230. The stops 238 both inhibit leakage of the coolant fluid 224 from the axial slots 230 while also driving the coolant fluid 224 against the windings 208 through the stop channels 244. The channels 242 in the stator core 206 and the stop channels 244 in the axial slots 230 thus provide convective cooling of the windings 208 and the stator core 206, improving operation of the electric machine 200.

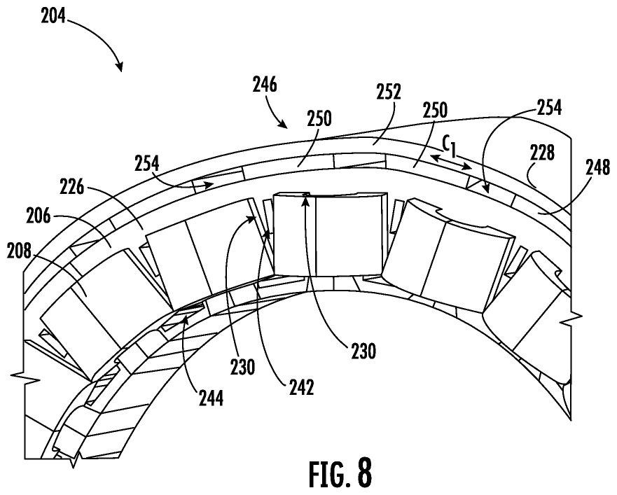

With reference to FIG. 8, a partial schematic view of another embodiment of a stator 204 is shown. More specifically, FIG. 8 shows a partial view of the stator 204 focusing on an extension 246 disposed on an exterior surface 248 of a stator core 206. It will be appreciated that portions of the stator 204 not shown in FIG. 8 include parts similar to those shown in FIG. 6 and described above.

The stator 204 includes one or more extensions 246 disposed on the exterior surface 248 of the stator core 206. FIG. 8 shows one extension 246, and it will be appreciated that the stator 204 may include a plurality of extensions 246 disposed circumferentially on the exterior surface 248 of the stator core 206. The extension 246 includes a plurality of bases 250 and a ring 252 extending between the bases 250. The bases 250 are fixed to the exterior surface 248, and the ring 252 defines a plurality of outer channels 254 with the exterior surface 248. The ring 252 extends in a circumferential direction C1 that substantially aligns with a curvature of the exterior surface 248.

When the cooling assembly 210 is attached to the stator core 206, the outer casings 214, 218 (FIGS. 2, 5) enclose the extension 246 and the outer channels 254. As with the stator 204 of FIGS. 6-7B, the stator core 206 includes channels 242 between adjacent axial slots 230 and stop channels 244. While the channels 242 shown in FIG. 8 have rectangular shapes and are disposed between the axial slots 230, the stator core 206 may include additional channels 242 with shapes and locations as shown in FIG. 7B, such as circular channels 242 disposed between axial slots 230 or arcuate channels 242 disposed outward of the axial slots 230. Coolant fluid 224 (FIG. 2) flows through the outer channels 254, the stop channels 244, and the channels 242 from a first end 226 of the stator core 206 to a second end 228 of the stator core 206. The outer channels 254 provide additional cooling to the exterior surface 248 of the stator core 206, improving operation of the electric machine 200.

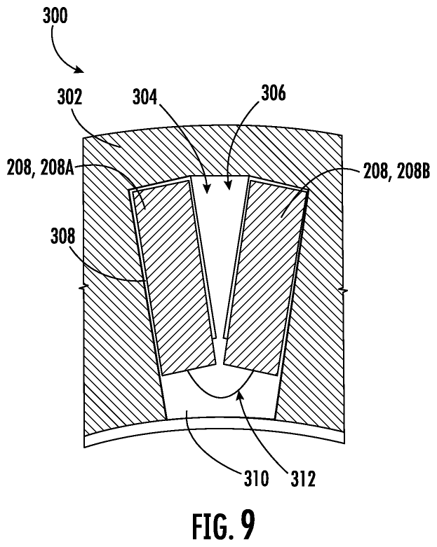

Now referring to FIG. 9, another exemplary stator 300 of an electric machine 200 is shown. FIG. 9 shows a cross-sectional view of a stator core 302 of the stator 300 with windings 208 disposed in an axial slot 304 of the stator core 302. The exemplary stator 300 of FIG. 9 may be configured in substantially the same manner as the exemplary stators 204 of FIGS. 2-8, and accordingly, the same or similar numbers may refer to the same or similar parts unless otherwise noted.

The stator core 302 defines a plurality of axial slots 304, one of which is shown in FIG. 9. The axial slot 304 houses two adjacent windings 208, including a first winding 208A and a second winding 208B. A channel 306 is defined between the first winding 208A and the second winding 208B, and a coolant fluid 224 flows in the channel 306 between the windings 208A, 208B, cooling the windings 208A, 208B.

The stator 300 includes an insulator 308, and a stop 310. The insulator 308 extends around the winding 208 to electrically insulate the winding 208 from the stator core 302. In particular, the stop 310 defines a stop channel 312 through which the coolant fluid 224 flows through the axial slot 304. In the exemplary embodiment of FIG. 9, the channel 306 and the stop channel 312 are fluidly connected, allowing for additional fluid motion and convective heat transfer.

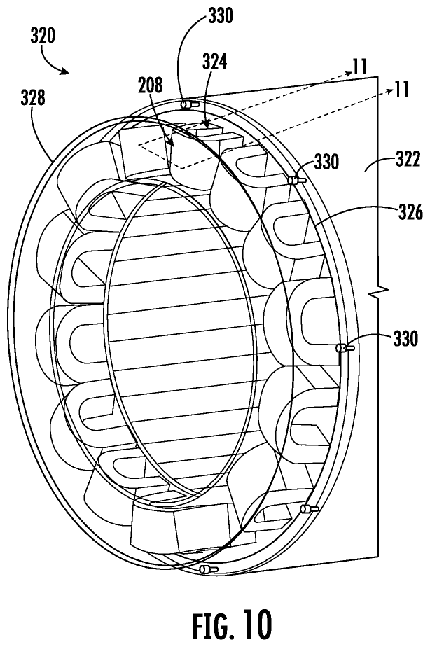

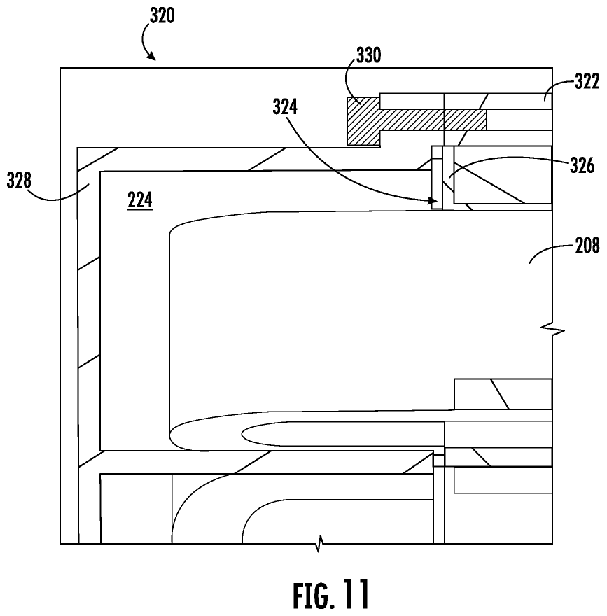

Now referring to FIGS. 10-11, another stator 320 of an electric machine 200 is shown. FIG. 10 shows a perspective view of the stator 320. FIG. 11 shows a cross-sectional view of the stator 320 along the line 11-11.

The stator 320 includes a stator core 322 with axial slots 324 defined within. Windings 208 are disposed in the axial slots 324. The stator 320 includes a seal member 326 and an outer casing 328 that hold the coolant fluid 224 for the windings 208. The outer casing 328 is fastened to the stator core 322 with fasteners 330, such as bolts, screws, pins, clamps, or combinations thereof. The fasteners 330 inhibit leakage of the coolant fluid 224 into the rotor 202, improving cooling of the windings 208 and reducing losses of the coolant fluid 224. While the views of FIGS. 10-11 show the seal member 326 and the outer casing 328 at a first end of the stator core 322, it will be appreciated that another outer casing would be fastened to the second end of the stator core 322 to secure the coolant in the axial slots 324.

Further aspects are provided by the subject matter of the following clauses:

An electric machine defines a radial direction, a circumferential direction, and an axial direction. The electric machine includes: a stator core including a first end and a second end and defining a plurality of axial slots extending in the axial direction from the first end to the second end, a seal member extending through the plurality of axial slots in the axial direction from the first end of the stator core to the second end of the stator core, a plurality of windings extending through the seal member in the axial direction and disposed in the plurality of axial slots, a first outer casing disposed at the first end over the seal member, the first outer casing including a fluid port, and a second outer casing disposed at the second end over the seal member, wherein the first outer casing, the second outer casing, and the seal member encapsulate the plurality of windings within the plurality of axial slots.

The electric machine of any of the preceding clauses, further including a fluid supply in fluid communication with the fluid port of the first outer casing.

The electric machine of any of the preceding clauses, wherein the fluid supply includes a coolant fluid.

The electric machine of any of the preceding clauses, wherein the coolant fluid is disposed through each of the plurality of axial slots.

The electric machine of any of the preceding clauses, wherein the first outer casing, the second outer casing, and the seal member form a fluidtight chamber encapsulating the plurality of windings.

The electric machine of any of the preceding clauses, wherein the second outer casing includes a second fluid port.

The electric machine of any of the preceding clauses, wherein the fluid port of the first outer casing is in fluid communication with the second fluid port of the second outer casing via the plurality of axial slots.

The electric machine of any of the preceding clauses, wherein the seal member includes a plurality of axial seals that extend around the stator core in the circumferential direction and a terminal seal disposed on the second end of the stator core.

The electric machine of any of the preceding clauses, wherein each of the plurality of axial seals includes a slot member extending through one of the plurality of axial slots and a stop extending in the circumferential direction across a width of the one of the plurality of slots.

The electric machine of any of the preceding clauses, wherein the stator core further comprises an inner surface in the radial direction and the seal member is flush with the inner surface of the stator core.

The electric machine of any of the preceding clauses, wherein the stator core defines a plurality of channels, each channel disposed between two of the plurality of windings.

An electric machine defines a radial direction, a circumferential direction, and an axial direction. The electric machine includes a stator core including a first end and a second end opposing the first end in the axial direction, the stator core defining a plurality of slots extending in the axial direction from the first end to the second end and a plurality of channels extending in the axial direction from the first end to the second end, each one of the plurality of channels being disposed between two adjacent ones of the plurality of slots in the circumferential direction, and a plurality of stops, each one of the plurality of stops disposed in one of the plurality of slots and extending in the circumferential direction across a width of the respective one of the plurality of slots and in the axial direction from the first end to the second end.

The electric machine of any of the preceding clauses, further including a plurality of windings, each one of the plurality of windings disposed in one of the plurality of slots.

The electric machine of any of the preceding clauses, wherein each one of the plurality of stops is disposed inward in the radial direction of the respective one of the plurality of windings disposed in the one of the plurality of slots.

The electric machine of any of the preceding clauses, wherein, in each one of the plurality of slots, the respective one of the plurality of stops disposed therein defines a stop channel with the respective one of the plurality of windings disposed therein, the stop channel extending in the axial direction from the first end of the stator core to the second end of the stator core.

The electric machine of any of the preceding clauses, further including an outer casing disposed at the first end of the stator core and the second end of the stator core, the outer casing encapsulating the plurality of windings within the plurality of slots.

The electric machine of any of the preceding clauses, wherein the stator core defines an inner surface in the radial direction, and the plurality of stops are flush with the inner surface of the stator core.

The electric machine of any of the preceding clauses, further including an extension disposed on an exterior surface of the stator core in the radial direction, the extension defining an outer channel with the exterior surface of the stator core.

The electric machine of any of the preceding clauses, further including a fluid port in fluid communication with the plurality of channels.

The electric machine of any of the preceding clauses, wherein the plurality of slots are arranged into a plurality of pairs of slots, each pair of slots including a first slot and a second slot, and wherein each of the plurality of channels is disposed between the respective first slot and the respective second slot of each of the plurality of pairs of slots.

The electric machine of any of the preceding clauses, wherein the plurality of windings include at least one of Litz wire conductors, stranded conductors, hairpin conductors, preformed solid coils, or combinations thereof.

The electric machine of any of the preceding clauses, wherein the outer casing is secured to the stator core with one or more fasteners.

The electric machine of any of the preceding clauses, wherein the fasteners include bolts, screws, pins, clamps, or combinations thereof.

The electric machine of any of the preceding clauses, wherein the seal member is formed of a fluidtight material.

The electric machine of any of the preceding clauses, wherein the fluidtight chamber is configured to inhibit leaking of coolant fluid.

The electric machine of any of the preceding clauses, wherein each one of the plurality of channels has one of a rectangular shape, a circular shape, or an arcuate shape.

The electric machine of any of the preceding clauses, wherein at least one of the plurality of channels is disposed radially outward of the windings.

A gas turbine engine including an electric machine of any of the preceding clauses.

The gas turbine engine of any of the preceding clauses, wherein the gas turbine engine is a three-stream engine.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An electric machine defining a radial direction, a circumferential direction, and an axial direction, the electric machine comprising:
a stator core including a first end and a second end and defining a plurality of axial slots extending in the axial direction from the first end to the second end;
a seal member extending through the plurality of axial slots in the axial direction from the first end of the stator core to the second end of the stator core;
a plurality of windings extending through the seal member in the axial direction and disposed in the plurality of axial slots;
a first outer casing disposed at the first end over the seal member, the first outer casing including a fluid port; and
a second outer casing disposed at the second end over the seal member, wherein the first outer casing, the second outer casing, and the seal member encapsulate the plurality of windings within the plurality of axial slots.

2. The electric machine of claim 1, further comprising a fluid supply in fluid communication with the fluid port of the first outer casing.

3. The electric machine of claim 2, wherein the fluid supply includes a coolant fluid.

4. The electric machine of claim 3, wherein the coolant fluid is disposed through each of the plurality of axial slots.

5. The electric machine of claim 1, wherein the first outer casing, the second outer casing, and the seal member form a fluidtight chamber encapsulating the plurality of windings.

6. The electric machine of claim 1, wherein the second outer casing includes a second fluid port.

7. The electric machine of claim 6, wherein the fluid port of the first outer casing is in fluid communication with the second fluid port of the second outer casing via the plurality of axial slots.

8. The electric machine of claim 1, wherein the seal member includes a plurality of axial seals that extend around the stator core in the circumferential direction and a terminal seal disposed on the second end of the stator core.

9. The electric machine of claim 8, wherein each of the plurality of axial seals includes:
a slot member extending through one of the plurality of axial slots; and
a stop extending in the circumferential direction across a width of the one of the plurality of axial slots.

10. The electric machine of claim 1, wherein the stator core further comprises an inner surface in the radial direction and the seal member is flush with the inner surface of the stator core.

11. The electric machine of claim 1, wherein the stator core defines a plurality of channels, each channel disposed between two of the plurality of windings.

12. An electric machine defining a radial direction, a circumferential direction, and an axial direction, the electric machine comprising:
a stator core including a first end and a second end opposing the first end in the axial direction, the stator core defining a plurality of slots extending in the axial direction from the first end to the second end and a plurality of channels extending in the axial direction from the first end to the second end, each one of the plurality of channels being disposed between two adjacent ones of the plurality of slots in the circumferential direction; and
a plurality of stops, each one of the plurality of stops disposed in one of the plurality of slots and extending in the circumferential direction across a width of the respective one of the plurality of slots and in the axial direction from the first end to the second end.

13. The electric machine of claim 12, further comprising a plurality of windings, each one of the plurality of windings disposed in one of the plurality of slots.

14. The electric machine of claim 13, wherein each one of the plurality of stops is disposed inward in the radial direction of the respective one of the plurality of windings disposed in the one of the plurality of slots.

15. The electric machine of claim 14, wherein, in each one of the plurality of slots, the respective one of the plurality of stops disposed therein defines a stop channel with the respective one of the plurality of windings disposed therein, the stop channel extending in the axial direction from the first end of the stator core to the second end of the stator core.

16. The electric machine of claim 13, further comprising an outer casing disposed at the first end of the stator core and the second end of the stator core, the outer casing encapsulating the plurality of windings within the plurality of slots.

17. The electric machine of claim 12, wherein the stator core defines an inner surface in the radial direction, and the plurality of stops are flush with the inner surface of the stator core.

18. The electric machine of claim 12, further comprising an extension disposed on an exterior surface of the stator core in the radial direction, the extension defining an outer channel with the exterior surface of the stator core.

19. The electric machine of claim 12, further comprising a fluid port in fluid communication with the plurality of channels.

20. The electric machine of claim 12, wherein the plurality of slots are arranged into a plurality of pairs of slots, each pair of slots including a first slot and a second slot, and wherein each of the plurality of channels is disposed between the respective first slot and the respective second slot of each of the plurality of pairs of slots.
